(19) United States
(12) Patent Application Publication
(10) Pub. No.: US 2004/0009401 A1
(43) Pub. Date: Jan. 15, 2004

(54) Lithium battery and method of removing water therefrom

(76) Inventors: Vijay P. Saharan, Grand Blanc, MI (US); Jeffrey L. Roberts, Saginaw, MI (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/192,209

(22) Filed: Jul. 10, 2002

(51) Int. Cl. H01M 10/04

(52) U.S. Cl. 429/231.95; 29/623.1

(57) ABSTRACT

Disclosed herein is a process of reducing water content within a lithium battery comprising contacting at least one component of the lithium battery having an initial amount of water, with a halogen substituted silicon compound capable of reaction with water, at a concentration, temperature, pressure, and for a period of time sufficient to reduce the initial amount of water. Also disclosed is a process of removing water from a lithium battery cell, comprising disposing within the lithium battery cell having an initial amount of water, a halogen substituted silicon compound capable of reaction with water, at a concentration sufficient to reduce the initial amount of water within the cell. Also disclosed is a lithium battery made from the disclosed processes.

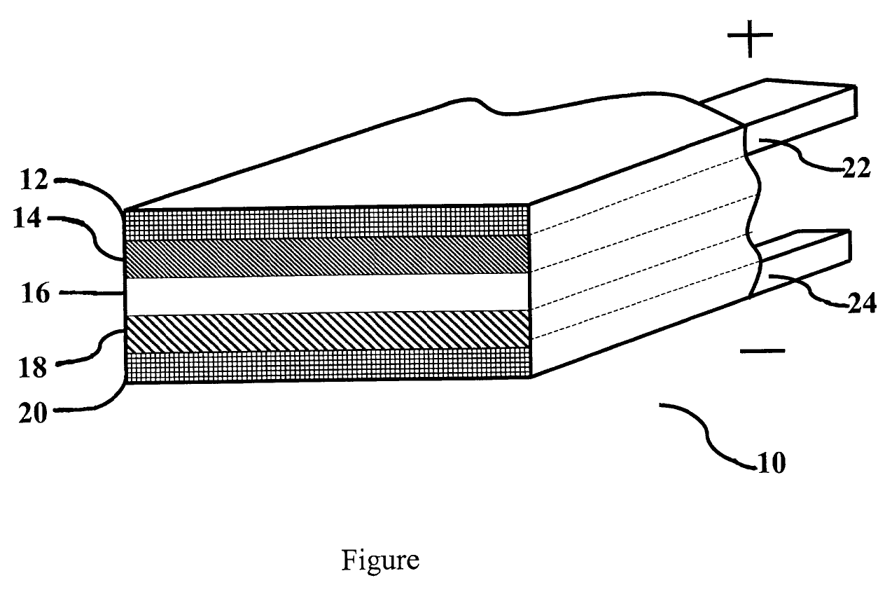

### BACKGROUND

Lithium batteries have gained popularity in uses ranging from portable electronics to electric automobiles, due in part to their energy density, discharge voltage characteristics, and environmentally friendly profile, especially when compared to alkali batteries, Ni-MH batteries, and Ni-Cd batteries. Lithium batteries are typically multi-cell structures, each cell having a positive electrode, a negative electrode, a separator, and a non-aqueous electrolyte. Both the electrodes and the separator typically contain a polymer matrix having lithium ions, and the electrolyte contains a lithium salt. The electrolyte can be a liquid, and may also be in gel form.

Lithium batteries are produced by forming each of the electrodes, the separator, and the other components separately, followed by laminating them together through the application of heat and pressure. After being laminated, the individual components are made porous by evaporation or extraction of a material incorporated into the components during manufacturing specifically for this purpose. The resultant porous laminate is then impregnated with electrolyte to form a functioning lithium battery cell.

Both the components contained within the cell, and the materials and methods used in manufacture and extraction can introduce water into the cell. These sources of water include atmospheric moisture, waters of hydration, and water present as a contaminant in the various materials. The water in the cell can then come into contact with cell components. Contact of water with electrolyte during charge or discharge results in oxidation of the electrolyte. The end result is formation of an interference layer or layers on the electrodes and other components within the cell. These interference layers increase the impedance of the cell while simultaneously decreasing coulombic efficiency. Water also reacts with fluorine salts in the electrolyte and forms hydrofluoric acid (HF), which is destructive to the individual cell components along with the cell as a whole. Accordingly, it is beneficial to remove and/or eliminate as much water as possible from within a lithium battery cell.

### SUMMARY

Disclosed herein is a process of reducing water content within a lithium battery comprising contacting at least one component of the lithium battery having an initial amount of water, with a halogen substituted silicon compound capable of reaction with water, at a concentration, temperature, pressure, and for a period of time sufficient to reduce the initial amount of water.

Also disclosed is a process of removing water from a lithium battery cell, comprising disposing within the lithium battery cell having an initial amount of water, a halogen substituted silicon compound capable of reaction with water, at a concentration sufficient to reduce the initial amount of water within the cell.

Further disclosed is a lithium battery comprising a plurality of battery components including an electrolyte disposed between, and in contact with both a positive electrode and a negative electrode, wherein an initial amount of water present in at least one of the components is reduced through contact of at least one of the components with a halogen substituted silicon compound capable of reaction with water, wherein the contact is for a period of time, and at a temperature and a pressure suitable to reduce the initial amount of water.

In addition, disclosed herein is a lithium battery cell comprising an electrolyte disposed between, and in contact with both a positive electrode and a negative electrode, and a halogen substituted silicone compound capable of reaction with water disposed within the cell, wherein an initial amount of water present in the cell has been reduced or eliminated through contact with the halogen substituted silicon compound within the cell.

The above described and other features are exemplified by the following figure and detailed description.

### BRIEF DESCRIPTION OF THE DRAWING

The FIGURE is a cross sectional schematic view of a lithium battery cell.

### DESCRIPTION OF THE PREFERRED EMBODIMENT

It has been unexpectedly discovered that by contacting the components of a lithium battery with a halogen substituted silicon compound capable of reaction with water (herein after “active halogenated silane”), and/or by incorporating such an active halogenated silane into a lithium battery, the water within a cell can be reduced and/or essentially eliminated (i.e., tied up) by chemical reaction between the water and the active halogenated silane.

A lithium battery cell contains a variety of battery components including a positive electrode, a negative electrode, and a non-aqueous electrolyte. Water present in a lithium battery cell may come from a variety of sources, including water vapor present in and on the components themselves (i.e., water on the surface of the electrodes, separators, cases and the like), water dissolved in the solvents used in making the cells (i.e., extraction solvents, casting solvents, washing solvents, and the like), and water in the components themselves (i.e., water in the electrolyte, the electrode matrix, waters of hydration present in the salts, and the like). In addition, water vapor may be entrapped and/or adsorbed during manufacturing. Accordingly, water can be substantially reduced or entirely eliminated from the cell by excluding it from the cell before fabrication or by removing it from within the fabricated cell (e.g., scavenged or converted) or some combination of both methods.

By a halogen substituted silicon compound capable of reaction with water it is meant a halogen and silicon containing material that scavenges and/or converts water to form an acid (e.g., HCl) by a reaction similar to that shown in Formula 1:

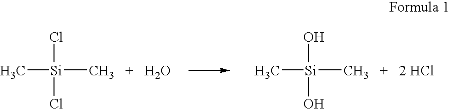

The formation of HCl from the active halogenated silane and water is believed to be beneficial to battery performance as compared to the formation of the HF that can form from reaction between water and other cell components. Accordingly, suitable halogen substituted silicon compounds are employed which react with water to produce materials less destructive to the cell than HF, preferably contain chlorine (Cl), bromine (Br), iodine (I), actinium (At), or a combination including at least one of the foregoing as is generally represented by Formula 2:

(X)ₐ(R)_{b}Si_{c} Formula 2:

wherein: X is a Cl, Br, I, or At, (a+b)=(2c+2), subject to the limitation that “a” is greater than or equal to one (a≧1), and each R, when present, is represents substituents that adhere to the rules of valence for the atoms to which they are attached, and is each independently selected from hydrogen, alkyls, alkenyls, alkynyls, hydroxyl, alkoxyl, silyloxy, amino, nitro, thiol, amines, imines, amides, phosphoryls, phosphonates, phosphines, carbonyls, carboxyls, silyls, ethers, thioethers, sulfonyls, selenoethers, ketones, aldehydes, esters, aryl, cycloalkyl, cycloalkenyl, heterocycle, polycycle, or a combination including at least one of the foregoing.

More preferably, the active halogenated silane is represented by Formula 3:

(X)ₐ(R)_{b}Si Formula 3

wherein X is a chlorine, (a+b)=4 subject to the limitation that “a” is at least equal to one (a≧1), and each R, when present, is methyl (—CH₃). Most preferably, the active halogenated silane is tetrachlorosilane (SiCi₄), Trichloromethylsilane (SiCl₃CH₃), Dichlorodimethylsilane (SiCl₂(CH₃)₂), chlorotrimethylsilane (SiCl(CH₃)₃), or a combination comprising at least one of the foregoing.

Turning now to the FIGUREigure, wherein a cross-sectional schematic view of a lithium battery cell is shown. Lithium battery cell 10 includes a positive current collector 12, a positive electrode 14, a separator 16, a negative electrode 18, and a negative current collector 20. Current collectors 12 and 20 each include an electrically conductive lug 22 and 24, respectively. Thus, multiple cells 10 are connectable to form a battery by appropriate connections of lugs 22 of positive current collector 12, and lugs 24 of negative current collectors 20. Accordingly, cells 10 are configurable to provide the battery with the desired current and voltage requirements.

Positive electrode 14, negative electrode 18, and the separator 16 are each generally formed into tapes or sheets separately, typically by tape casting. Tape casting, also known as doctor blading and knife coating involves a number of steps. The polymer matrix starting materials, typically dissolved in a casting solvent, are fed in liquid form onto a moving surface to be coated. A scraping blade, known as the “doctor” is set a distance above the moving material to remove excess substances and thus determines the film thickness. Heat and drying are then applied and the tape is collected.

While tape casting can produce the films having the thickness required for use in Li batteries, the films produced are not porous. To impart porosity into the films (i.e., electrodes and separator) the polymer matrix is formed having both an insoluble fraction and a removable fraction. The insoluble fraction of the polymer matrix includes polyvinylidine fluoride, polyvinyl chloride, polyacrylonitrile, ethylene acrylic acid copolymer, ethylene propylene diene monomer, porous polypropylene, porous polyethylene, ethylene vinyl acetate, polybutadiene, polyethylene oxide, polyethylenimine, polyisoprene, polymethacrylonitrile, polymethylacrylate, polymethyl methacrylate, polypropylene oxide, polystyrene, polytetrafluoroethylene, polythiophenes, polyphosphazenes, polyvinyl acetate, polyvinyl alcohol, polyvinylpyrrolidone, polyvinylidene hexafluoropropene copolymer and copolymers and having any one of the foregoing polymers. Preferred polymers for the insoluble fraction are polyvinylidine fluoride, polyvinyl chloride, and polyacrylonitrile.

The removable fraction of the polymer matrix is preferably dibutylphthalate, N-methylpyrrolidone, and/or propylene carbonate. The weight fraction of the removable soluble fraction is about 1 to about 90 weight percent (wt %) of the total weight of the polymeric matrix. Preferably within this range, the weight fraction of the removable soluble fraction is greater than or equal to about 5, preferably greater than or equal to about 10 wt %. It is also desirable for the weight fraction of the removable fraction to be less than or equal to about 50, preferably less than or equal to about 25 wt %.

Suitable casting solvents are capable of solubilizing the polymer matrix, and include, for example, acetonitrile, butyrolactone, 1,2-diethoxy ethane, ethylene carbonate, diethyl carbonate, 1,2-dimethoxy ethane, acetone, dimethylacetamide, dimethyl carbonate, dimethylformamide, dimethylsulfoxide, dioxolane, methylformate, N,N-methylpyrolidinone, 2-methyltetrahydrofuran, propylene carbonate, sulfolane, tetrahydrofuran, diethyl ether, dimethylformamide, xylene, tetramethylurea, and mixtures thereof. Preferred organic solvents include ethylene carbonate, diethyl carbonate, propylene carbonate, acetone, tetrahydrofuran, diethyl ether, dimethylformamide, dimethylsulfoxide, xylene and mixtures comprising at least one of the foregoing.

The positive electrode is preferably prepared by casting a solution comprising the polymer matrix and solvent, and an active material. A suitable active material can be a metal oxide, including nickel cobalt aluminum oxide, lithiated nickel cobalt aluminum oxide, nickel cobalt oxide, lithiated nickel cobalt oxide and mixtures thereof. Lithiated nickel cobalt aluminum phosphate, lithiated nickel cobalt phosphate, manganese oxide, lithiated manganese oxide, cobalt oxide, lithiated cobalt oxide, nickel oxide, lithiated nickel oxide, lithiated iron phosphate, and lithiated vanadium oxides and phosphates may also be used.

After casting and evaporation of any solvent, the positive electrode typically has a thickness of about 50 to about 400 micrometers. Preferably within this range, the positive electrode thickness is greater than or equal to about 75, preferably greater than or equal to about 100 micrometers. Also within this range, the positive electrode thickness is preferably less than or equal to about 200, more preferably less than or equal to about 150 micrometers.

In addition, the positive electrode has an active material weight percent (wt %) of about 30 to about 95 wt %. Preferably within this range, the active material is greater than or equal to about 50, more preferably greater than or equal to about 60 wt %. Also within this range, the active material is less than or equal to about 80, more preferably less than or equal to about 70 wt %.

The negative electrode is preferably cast from a solution containing polymer matrix, solvent, and a carbon-based material including synthetic graphite, petroleum coke, carbon coke, natural graphite, Super P and Super S battery carbon (Minnesota Mining and Minerals), Shawinigan Black (Chevron Chemical), acetylene black, carbon fibers, graphite fibers, and/or graphite intercalated compounds. Suitable graphite intercalated compounds include carbon and/or graphite doped and/or coated with antimony, arsenic, barium, boron, calcium, cobalt, iron, manganese, nickel, phosphorus, potassium, sodium, strontium and/or zinc. The preferred carbon-based materials are synthetic graphite, petroleum coke, or carbon coke.

After casting and evaporation of any solvent, the negative electrode typically has a thickness of about 50 to about 400 micrometers. Preferably within this range, the negative electrode thickness is greater than or equal to about 75, preferably greater than or equal to about 80 micrometers. Also within this range, the negative electrode thickness is preferably less than or equal to about 200, more preferably less than or equal to about 175 micrometers.

A weight-to-weight ratio (wt/wt) of active cathode to active anode is about 1 to about 3.0 (wt/wt). Preferably within this range, the weight ratio is greater than or equal to about 1.5, preferably greater than or equal to about 1.6 wt/wt. Also within this range, the weight ratio is preferably less than or equal to about 2.2, more preferably less than or equal to about 2.0 wt/wt.

The separator is typically cast from a solution including polymer matrix, solvent, and a porous filler, and may be single or multilayered. Preferred polymer matrix materials of the layers may include polyvinylidene difluoride, hexafluoropropylene, porous polypropylene and/or porous polyethylene, and the like. Suitable porous filler materials include fumed silica, aluminum oxides, aluminates, zeolites, zirconates, and combinations comprising at least one of the foregoing.

After casting and evaporation of any solvent, the separator generally has a porosity of about 30 to about 60 volume percent (vol %) based on the pore area to the total surface area. Preferably within this range, porosity is greater than or equal to about 35, preferably greater than or equal to about 40 vol %. Also within this range, the porosity is preferably less than or equal to about 55, more preferably less than or equal to about 50 vol %. The maximum pore size is preferably about 45 micrometers.

The separator typically has a thickness about 1 to about 40 micrometers. Preferably within this range, the separator thickness is greater than or equal to about 5, preferably greater than or equal to about 10 micrometers. Also within this range, the separator thickness is preferably less than or equal to about 20, more preferably less than or equal to about 15 micrometers.

In the manufacture of the cell, the electrodes 14, 18 and separator 16 may be laminated prior to imparting porosity into the laminate, and/or the current collectors 12, 20, electrodes 14, 18, and separator 16 may be laminated prior to pore formation.

The positive collector is generally a conductive grid or foil including, for example, aluminum mesh or aluminum coated with nickel, platinum, palladium or cobalt, or an aluminum alloy doped with boron, iron, lead, tin, silicon or zinc. The positive collector may also be coated with a layer including a polymeric matrix, graphite, and/or conductive carbon.

The negative collector is a conductive grid or foil including, for example, copper, nickel, or aluminum, alloys such as stainless steel, or a copper intermetallic such as copper niobium, with copper being preferred. The negative collector may also be coated with a layer including polymeric matrix, graphite, and conductive carbon.

As stated above, the various layers that form the laminate are not porous. To impart porosity into the laminate, the components are subjected to pore formation. Preferably, removing a soluble fraction incorporated into the various layers by extraction with a solvent, for example, liquid carbon dioxide forms the pores. For example, the laminate is immersed in the solvent thereby remove the soluble matrix portion and leaving behind a porous material. Pore formation can also include evaporation of a removable fraction by treatment of the material at an elevated temperature and/or reduced pressure (e.g., heating in a vacuum) to remove the fraction.

After further lamination with the current collectors, if required, the laminate is contacted with the electrolyte. Suitable electrolytes include, for example, salts of lithium hexafluorophosphate, lithium hexafluoroarsenate, lithium perchlorate, lithium tetrafluoroborate, lithium trifluoromethanesulfonate, lithium trifluoromethansulfonimide, lithium trifluorocarbonate, and mixtures comprising at least one of the foregoing.

The improvement in water removal disclosed herein can be achieved by adding a suitable amount of the active halogenated silane directly to one or more of the individual components (i.e., the positive electrode, the negative electrode, the separator and/or the electrolyte), and/or by adding a suitable active halogenated silane prior to, during or after preparation of the components. In addition, the electrodes, separator, and/or electrolyte itself may be brought into contact with the active halogenated silane by, for example, dipping into a solution containing active halogenated silane, and/or contacting with liquid and/or vapor of the active halogenated silane at a suitable temperature, pressure and for a suitable period of time to remove the desired amount of water. Contacting with the active halogenated silane may also be used in conjunction with other processes to facilitate water and by-product removal, including the application of heat, vacuum, dry gas purge, combinations thereof, and the like, either before, during, and/or after contacting with the active halogenated silane.

When the active halogenated silane is directly added to the battery cell, which is then sealed, the amount of active halogenated silane added depends on the total amount of water present. The active halogenated silane is added in a stoichiometric ratio of equivalents of active halogenated silane to equivalents water of about 0.8 to about 200. Preferably within this range, active halogenated silane to water stoichiometric ratio is greater than or equal to about 1, preferably greater than or equal to about 1.5. Also within this range, the ratio is preferably less than or equal to about 50, more preferably less than or equal to about 25.

When the various components are brought into contact with the active halogenated silane in the vapor phase, the amount of active halogenated silane present depends on the total amount of water present. The active halogenated silane is present in the vapor phase in a stoichiometric ratio of equivalents active halogenated silane to equivalents water of about 0.8 to about 200. Preferably within this range, active halogenated silane to water stoichiometric ratio is greater than or equal to about 10, preferably greater than or equal to about 20. Also within this range, the ratio is preferably less than or equal to about 50, more preferably less than or equal to about 25.

Furthermore, the active halogenated silane is brought into contact at a temperature of about 10° C. to about 200° C. Preferably within this range, the temperature is greater than or equal to about 25, preferably greater than or equal to about 30° C. Also within this range, the temperature is preferably less than or equal to about 100, more preferably less than or equal to about 50° C.

The time required for vapor phase contact depends on the total amount of water present, the temperature, and the concentration of the active halogenated silane, and is about 1 second to about 200 hours. Preferably within this range, active halogenated silane contact time is greater than or equal to about 10, preferably greater than or equal to about 60 seconds. Also within this range, the ratio is preferably less than or equal to about 1, more preferably less than or equal to about 0.5 hours. However, the actual time required is readily determined by one of skill in the art without undue experimentation.

### EXAMPLES

Dehydration of Cathode Extracted Material:

Three dry 30 ml bottles were charged with glass beads to approximately one third the total volume. Three similar portions of extracted cathode material were placed on top of the glass beads, one each per bottle. The first bottle (#1) was sealed for use as a Comparative Example. The second bottle (#2) was charged with 0.5 ml hexamethyldisilizane, and the third bottle (#3) was charged with 0.5 ml dimethyldichlorosilane. All three bottles were then aged at room temperature (25° C.) for 72 hours and the water content of the cathode material determined, and are listed below in Table 1:

TABLE 1
Dehydration of Positive Cathode Material

| | | Water |
|---|---|---|
| Sample No. | Dehydration Agent | ppm* |
| #1 (Comparative | none | 1156 |
| Example) | | |
| #2 | HMDS | 526 |
| #3 | SiCl₂(CH₃)₂ | 56 |

*Mitsubishi CA100/VA100 Karl Fischer Analyzer, 160 degrees C. Both dimethyldichlorosilane and hexamethyldisilizane clearly remove water from the cathode material through vapor phase contact.

Comparative performance of silanes used as dehydrating agents was also evaluated. Chlorosilanes each having from one to four chlorines in each molecule, and hexamethyldisilazane were evaluated for dehydration effectiveness on a lithium battery cathode film material. The cathode material was placed in a closed container on top of glass beads wetted with the silane being tested, and exposed for 48 hours. Some cathode material samples appeared to have wicked up portions of the silane used. These were dried for 60 minutes under vacuum at room temperature before analysis. The results are presented in Table 2:

TABLE 2

| | | Grams of | Karl Fischer |
|---|---|---|---|
| | Grams of | FMC600 | moisture |
| Material | material added | cathode film | (160° C.) Ppm |
| Chlorotrimethylsilane | 0.878 | 0.546 | 501 |
| Dichlorodimethylsilane | 0.707 | 0.540 | 345 |
| Methyltrichlorosilane | 1.228 | 0.531 | 324 |
| Silicon tetrachloride | 1.426 | 0.481 | 173 |
| Hexamethyldisilazane | 0.567 | 0.520 | 484 |
| FMC600 | 0.0 | 0.554 | 1767 |
| (Comparative Blank | | | |
| Sample) | | | |

The data shows silicon tetrachloride as being the most effective dehydrating compound. The effects are also shown to be proportional to the number of chlorine atoms attached to the silicon atom.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A process of reducing water content within a lithium battery comprising:
contacting at least one component of said lithium battery having an initial amount of water, with a halogen substituted silicon compound capable of reaction with water, at a concentration, temperature, pressure, and for a period of time sufficient to reduce said initial amount of water.

2. The process of claim 1, wherein said halogen substituted silicon compound is represented by the formula:
(X)ₐ(R)_{b}Si_{c},
wherein: X is Cl, Br, I, At, or a combination including one of the foregoing;
a+b=2c+2, subject to the limitation that “a” is equal to, or greater than one; and
each R, when present, represents substituents that adhere to the rules of valence for the atoms to which they are attached, and is each independently hydrogen, alkyls, alkenyls, alkynyls, hydroxyl, alkoxyl, silyloxy, amino, nitro, thiol, amines, imines, amides, phosphoryls, phosphonates, phosphines, carbonyls, carboxyls, silyls, ethers, thioethers, sulfonyls, selenoethers, ketones, aldehydes, esters, aryl, cycloalkyl, cycloalkenyl, heterocycle, polycycle, or a combination comprising at least one of the foregoing.

3. The process of claim 2, wherein said halogen substituted silicon compound is represented by the formula:
(X)ₐ(R)_{b}Si
wherein X is chlorine;
a+b=4; subject to the limitation that “a” is equal to, or greater than one; and
R, when present, is methyl.

4. The process of claim 1, wherein said halogen substituted silicone compound is present during said contacting at a stoichiometric ratio of about 0.8 to about 200 total equivalents of said halogen substituted silicone compound per the total equivalents of said initial amount of water, wherein one equivalent weight of said halogen substituted silicone compound is defined as the amount capable of reacting with one molecular weight of water under the contacting conditions.

5. The process of claim 1, wherein said at least one component is contacted with a vapor of said halogen substituted silicon compound.

6. A process of removing water from a lithium battery cell, comprising:
disposing within said lithium battery cell having an initial amount of water, a halogen substituted silicon compound capable of reaction with water, at a concentration sufficient to reduce said initial amount of water within said cell.

7. The process of claim 6, wherein said halogen substituted silicon compound is represented by the formula:
(X)ₐ(R)_{b}Si_{c},
wherein: X is Cl, Br, I, At, or a combination including one of the foregoing;
a+b=2c+2, subject to the limitation that “a” is equal to, or greater than one; and
each R, when present, represents substituents that adhere to the rules of valence for the atoms to which they are attached, and is each independently hydrogen, alkyls, alkenyls, alkynyls, hydroxyl, alkoxyl, silyloxy, amino, nitro, thiol, amines, imines, amides, phosphoryls, phosphonates, phosphines, carbonyls, carboxyls, silyls, ethers, thioethers, sulfonyls, selenoethers, ketones, aldehydes, esters, aryl, cycloalkyl, cycloalkenyl, heterocycle, polycycle, or a combination comprising at least one of the foregoing.

8. The process of claim 7, wherein said halogen substituted silicon compound is represented by the formula:
(X)ₐ(R)_{b}Si
wherein X is chlorine;
a+b=4; subject to the limitation that “a” is equal to, or greater than one; and
R, when present, is methyl.

9. The process of claim 6, wherein said halogen substituted silicone compound is present in said cell at a stoichiometric ratio of about 0.8 to about 200 total equivalents of said halogen substituted silicone compound per the total equivalents of said initial amount of water, wherein one equivalent weight of said halogen substituted silicone compound is defined as the amount capable of reacting with one molecular weight of water under cell conditions.

10. A lithium battery comprising:
a plurality of battery components including an electrolyte disposed between, and in contact with both a positive electrode and a negative electrode, wherein an initial amount of water present in at least one of said components is reduced through contact of at least one of said components with a halogen substituted silicon compound capable of reaction with water, wherein said contact is for a period of time, and at a temperature and a pressure suitable to reduce said initial amount of water.

11. The battery of claim 10, wherein said halogen substituted silicon compound is represented by the formula:
(X)ₐ(R)_{b}Si_{c},
wherein: X is Cl, Br, I, At, or a combination including one of the foregoing;
a+b=2c+2, subject to the limitation that “a” is equal to, or greater than one; and
each R, when present, represents substituents that adhere to the rules of valence for the atoms to which they are attached, and is each independently hydrogen, alkyls, alkenyls, alkynyls, hydroxyl, alkoxyl, silyloxy, amino, nitro, thiol, amines, imines, arnides, phosphoryls, phosphonates, phosphines, carbonyls, carboxyls, silyls, ethers, thioethers, sulfonyls, selenoethers, ketones, aldehydes, esters, aryl, cycloalkyl, cycloalkenyl, heterocycle, polycycle, or a combination comprising at least one of the foregoing.

12. The battery of claim 11, wherein said halogen substituted silicon compound is represented by the formula:
(X)ₐ(R)_{b}Si
wherein X is chlorine;
a+b=4; subject to the limitation that “a” is equal to, or greater than one; and
R, when present, is methyl.

13. The battery of claim 10, wherein said halogen substituted silicone compound contact is at a stoichiometric ratio of about 0.8 to about 200 total equivalents of said halogen substituted silicone compound per the total equivalents of said initial amount of water, wherein one equivalent weight of said halogen substituted silicone compound is defined as the amount capable of reacting with one molecular weight of water under the contacting conditions.

14. The battery of claim 10, wherein said contact is between said at least one of said components and a vapor of said halogen substituted silicon compound

15. A lithium battery cell comprising:
an electrolyte disposed between, and in contact with both a positive electrode and a negative electrode, and a halogen substituted silicone compound capable of reaction with water disposed within said cell, wherein an initial amount of water present in said cell has been reduced or eliminated through contact with said halogen substituted silicon compound within said cell.

16. The battery of claim 15, wherein said halogen substituted silicon compound is represented by the formula:
(X)ₐ(R)_{b}Si_{c},
wherein: X is Cl, Br, I, At, or a combination including one of the foregoing;
a+b=2c+2, subject to the limitation that “a” is equal to, or greater than one; and
each R, when present, represents substituents that adhere to the rules of valence for the atoms to which they are attached, and is each independently hydrogen, alkyls, alkenyls, alkynyls, hydroxyl, alkoxyl, silyloxy, amino, nitro, thiol, amines, imines, armides, phosphoryls, phosphonates, phosphines, carbonyls, carboxyls, silyls, ethers, thioethers, sulfonyls, selenoethers, ketones, aldehydes, esters, aryl, cycloalkyl, cycloalkenyl, heterocycle, polycycle, or a combination comprising at least one of the foregoing.

17. The battery of claim 16, wherein said halogen substituted silicon compound is represented by the formula:
(X)ₐ(R)_{b}Si
wherein X is chlorine;
a+b=4; subject to the limitation that “a” is equal to, or greater than one; and
R, when present, is methyl.

18. The battery of claim 15, wherein said halogen substituted silicone compound is present in said cell at a stoichiometric ratio of about 0.8 to about 200 total equivalents of said halogen substituted silicone compound per the total equivalents of said initial amount of water, wherein one equivalent weight of said halogen substituted silicone compound is defined as the amount capable of reacting with one molecular weight of water under the contacting conditions.
